(19) United States
(12) Patent Application Publication
(10) Pub. No.: US 2026/0245530 A1
(43) Pub. Date: Aug. 20, 2026

(54) Miniaturized Universal Tuning Machine for Stringed Instruments

(71) Applicants: Sean Thomas Moran, Corvallis, OR (US); Steven Blake Gazeley, West Linn, OR (US)

(72) Inventors: Sean Thomas Moran, Corvallis, OR (US); Steven Blake Gazeley, West Linn, OR (US)

(21) Appl. No.: 19/054,891

(22) Filed: Feb. 16, 2025

(51) Int. Cl. G10D 3/14

(52) U.S. Cl. CPC G10D 3/14

(57) ABSTRACT

The miniaturized universal tuning machine provides precise and stable string tension adjustments for stringed musical instruments. The compact, light and relatively inexpensive apparatus solves several key problems in the industry to enable light and highly portable musical instruments without sacrificing performance. The tuning machine can be configured for any numbers of strings and any string gage adding to its versatility and applicability. The tuning machine comprises a base part, a tensioning screw, and a carriage. The carriage includes securely holds the instrument string and a threaded interface with the tensioning screw to control relative position between the parts. Various methods for securing the string end and versatile mounting options are included. The tuning machine can be installed inside a pocket in the instrument resulting in a virtually invisible tuning system with no protruding features while enabling a sleek and stylish instrument appearance.

### BACKGROUND OF THE INVENTION

Stringed musical instruments have long relied on mechanical tuning machines to adjust the tension and pitch of their strings. Currently available tuning machines lack performance in several areas such as bulkiness and weight, protruding elements, limited precision, high costs, poor tension stability. One often overlooked performance criteria for musical instruments is the environmental, carbon footprint, and international trade imbalance costs of the technology. For musicians, especially those who perform regularly or travel frequently, the size, weight, and expense of their instruments can significantly impact their experience and often result in musicians leaving their instruments behind when traveling. Additionally, the majority of musical instruments are not properly in tune when the musician seeks them, resulting in lack of readiness to play; each instrument requiring tuning prior to each playing session. This occurs for the majority of musical instruments due to a flaw in the design of tuning machines. Currently available tuning machines have exposed tuning elements which virtually ensures the musical instrument will not be properly tuned after handling. The exposed elements are easily disturbed during normal everyday handling resulting in poorly tuned instruments.

Today's musicians also care passionately about the future of our planet, our natural environment, and the environmental footprint of the products they purchase. Musicians have a severe lack of options to purchase instruments that meet their demands for environmentally friendly instruments that do not sacrifice musical performance. Today's musicians seek purchasing alternatives for musical instruments that reduce the lifecycle and environmental costs associated with metal ore mining, international shipping, sustainably grown woods, pollution reduction, trade imbalances and several other factors concerning a sustainable global future. The present invention contributes major advances in all of these areas as compared to the state-of-the-art.

Many types of string tensioning systems have been developed since the inception of stringed musical instruments several hundred years ago. Metal alloy strings and hybrid strings offer high levels of variety for musicians who seek high performance and quality that will result in excellent string sound quality. Tension forces in metallic strings can be relatively high as compared to nylon and other hybrid string materials that are designed to simulate the soft sounds of traditional animal product-based strings of the past. High tension metallic and hybrid string technologies available today have enabled unparalleled capabilities, variety and benefits to musicians. These technologies have enabled the invention of electrified instrument, which use the principles of electromagnetism to generate electrical signal waveforms that can be easily reproduced and amplified using analog and digital amplification systems. These high-tension metallic strings also created new challenges for musical instrument designers due to the high degree of string tension forces of these strings. Innovations in instrument design to accommodate these higher forces are well established in the state-of-the-art, including neck truss rods to add strength to instrument necks, instrument body bracing innovations in electric-acoustic hybrid instruments, and specifically in the design of tuning machines.

Many types of tuning machines are currently available in the industry, including friction tuners, gear-based tuners, and even tuners for instruments that do not have a traditional head. The instrument head is a convenient and common location to mount tuning machines, but with the advent of headless instruments, other types of tuning machines were invented and are readily available for musicians and musical instrument designers. The prior art search attached to this patent filing provide a sampling of industry-standard tuning machines that are available to musicians and instrument designers.

The invention of the electric guitar created additional innovation opportunities that have led to many industry accepted technologies. One such line of inventions is commonly referred to the “Floyd Rose”, which is affectionately named after the inventor of the technology. Many patents were awarded to Floyd D. Rose, and several are referenced in this patent application. Several of these inventions integrate string clamping and string tensioning in complex devices generally located at the bridge of the guitar (U.S. Pat. No. 8,946,529B2). This type of technology enables additional capabilities to players and instrument designers, including a locking nut, and fine string tuning at the saddle areas of the instrument. These inventions are impressive in capability and quality, but are large, heavy, complicated to operate, expensive, and have relatively high energy and environmental footprint to our planet, which results in large, heavy, expensive, and environmentally unfriendly musical instruments.

One other prolific inventor in this industry is Ned Steinberger who has developed many types of devices with applicability to stringed instruments. One focus of Steinberger has been to enable instruments without traditional heads, which necessitated the need for combined tuning and adjustments for string length and pitch near the bridge of the instrument. One such invention is noted in U.S. Pat. No. 7,888,571B2, including citations to many other similar devices. The prior art noted in this patent as well in its citations provide a detailed summary of related art that is hereby referenced as well. As will be clearly observed the technology is designed for high performance, but is also very expensive, heavy and large. The environmental and energy costs associated with these types of devices is relatively high compared to the present invention. The present invention solves the unmet needs of marketplace for small, light, inexpensive, high-performance, portable, and environmentally sound instruments not met by Steinberger, Rose, or other technology in the present state-of-the-art.

The underlying physics governing the sound generated by a vibrating string is well studied by physicists and actively implemented by musical instrument designers and musicians. The natural frequency of string vibration is a function of string tension, string linear density, and string length. The present invention is specifically focused on string tension. One necessary element concerning the performance of stringed instruments is the ability to adjust the length of the string. String length is a critical factor to ensure proper pitch matching the design of the specific instrument and specific string. Many stringed instruments have adjustable elements that enable small adjustments of string length to enable to user to adjust the instrument for proper string length and pitch. The present invention is not intended to perform this important function, but rather only to adjust string tension and therefore string natural frequency of vibration. Any musical instrument using the present invention will account for string length as part of the instrument design as is commonly done in the state-of-the-art for many instruments. The string linear density is selected by the instrument designer as well and the user and can be adjusted as part of the fixed instrument design, or by using adjustment elements as described and as common in the industry.

Several significant problems with current tuning machines are their weight, protruding tuning elements, susceptibility to accidental detuning, and high expense for quality machines. The weight of traditional tuning machines can negatively impact the overall feel and balance of the instrument, making it cumbersome for musicians. Furthermore, these tuning machines often have protruding tuning elements, including keys that require additional space and add to the instrument's weight. This can be particularly problematic for musicians who prefer lighter instruments or need to transport their instruments frequently. Protruding tuning keys can also be accidentally bumped, leading to unintended detuning of the instrument, further disrupting a musician's performance and their playing experience. Lastly, high-quality tuning machines tend to be expensive, making it difficult for some musicians to afford them, while lower-cost alternatives often result in poor performance and reliability. An additional problem with traditional stringed instruments is their size and lack of durability, often resulting in musicians leaving their instruments at home during travel due to concerns about instrument damage and travel inconvenience. This is particularly the case during travel where space is limited, such as on airplanes, in packed cars, on business trips, or during adventurous recreational travel.

The present invention addresses these problems by providing a more compact, efficient, light, lower cost, protected, and precise tuning system that can be easily integrated into various stringed instruments, including guitars, violins, ukuleles, banjos, bass guitars and other stringed instruments. The miniaturized universal tuning machine combines the reliability and simplicity of use of traditional high quality mechanical tuners with the precision and convenience demanded by modern musicians. Its innovative design ensures that it maintains tuning stability even under varying environmental conditions, such as changes in temperature and humidity, which can affect string tension and pitch.

Major benefits of the miniaturized tuning machine include its ability to be integrated into the musical instrument to reduce weight, remove protruding elements, and reduce the structural support required for the tuning machine. This results in a much smaller, lighter, and more portable musical instrument. The compact design also eliminates the risk of accidental detuning by eliminating protruding tuning keys.

Furthermore, the lighter and smaller musical instruments enabled by the present invention make it feasible for musicians to take their instruments during travel that would typically be impossible, impractical, or too risky for instrument damage. This is particularly useful for travel that requires efficient use of space, such as on airplanes, in packed cars, on business travel, recreational travel, and during adventurous excursions. Smaller, lighter and more portable musical instruments will enable musicians to carry their instruments to places not normally associated with live music, further increasing their ability to play, and enhancing the experiences of others. By reducing the size and weight of the tuning mechanism, the overall playability and comfort of the instrument are significantly enhanced, making it easier for musicians of all ages and skill levels to enjoy playing in a variety of settings.

The smaller and lighter musical instruments enabled by the present invention have intrinsically lower environmental and energy footprints for raw materials, production, shipping and use as compared to the state-of-the-art. These newly possible instruments use substantially less raw materials, finishing chemicals and other materials potentially resulting with musical instruments with only a small fraction of the energy and environmental footprint of comparable high-performance instruments. Today's musician's will now have musical instrument alternatives to meet their demanding requirements beyond just the musical performance of the instrument.

The present invention provides a simple, small, light, inexpensive, and environmentally friendly solution for stringed instruments to address the unmet need of smaller, lighter and more portable musical instruments and also are capable of high performance required by musicians. One useful value of the present invention is the ability to enable highly environmentally friendly musical instruments that require only a tiny fraction of energy and materials to produce, while also ensuring high quality and performance demanded by today's musicians.

The smaller size of the disclosed tuning machine also allows for greater design and construction flexibility of stringed instruments. Luthiers and instrument manufacturers can create more elegant and streamlined instrument designs without sacrificing the functionality and reliability of the tuning system. This is true for mass-produced instruments, as well as custom-built instruments, where aesthetics and performance are equally important.

### BRIEF SUMMARY OF THE INVENTION

The present invention overcomes all of the problems unaddressed by prior art and the current industry state-of-the-art and is superior to the combined functionality of present and past technologies. The unique and innovative properties and features of the present invention also enable additional benefits over the state of the art, as disclosed herein.

The present invention provides a universal, miniaturized, self-contained string tensioning device, or tuning machine, specifically designed for tensioning of strings for stringed musical instruments, offering a significant reduction in size, weight, cost, and environmental and energy footprint, compared to traditional tuning machines. This miniaturized tuning machine features a highly accurate and efficient tuning system, fine adjustment screw for precise string tension adjustments, and a design that fits seamlessly within the headstock, tailstock, or body of various stringed instruments.

### Main Features

1) Super Fine Tension Adjustments: A fine-pitched tensioning screw, or screws for multiple-string configurations, enables ultra-fine resolution of tension for continuous and fine adjustments to string tension, ensuring exact and stable tuning for prolonged periods.
2) Versatile Mounting Options: The self-contained tuning machine is designed to be installed inside a subsurface pocket in the instrument head, tail, or body, offering flexibility for design and installation.
3) Hidden Installation: The tuning machine can be installed inside the head, tail, or body, of the instrument, virtually completely hidden from view. The string tensioning screw can be accessed from the end of the head or tail, creating an instrument with no protruding elements. The hidden placement of the tensioning screw ensures it cannot be accidentally bumped, preventing unintentional detuning. The hidden tuning machine configuration protects the tuning machine from contaminants and the environment further enhancing the performance, especially during transportation and handling or when using in adverse environments.
4) Configurable for Any Number of Strings and Any String Gage: The tuning machine can be configured to support any number of strings and any string gauge within the self-contained package, unlike traditional stringed instruments that generally provide a separate tuning machine for each string. Even as compared to tuning machines for headless guitars, where each string has its own tensioner and actuation device, the present invention can be made more compact, lighter, and can also be hidden. This further reduces the space required for the instrument and the tuning machine, as well as the costs, size, and weight of the instrument.
5) User-Friendly Design: The tuning machine is simple and easy to use with a single hand and without the need for the user to directly see the tuning machine while adjusting it with only minimal training. Users of any skill level can benefit from the tuning machine.
6) Integration Capability: The design allows easy installation into the headstock, tail, or body area of many stringed instruments, including guitars, violins, ukuleles, banjos, mandolins, and bass guitars, without compromising instrument aesthetics or playability.
7) Light Weight, Small Size and Low Cost: The present invention solves the problems associated with other technologies and addresses the unmet needs discussed herein, including the need for small, light, low cost, and portable stringed instruments also with a significantly lower environmental and energy footprint.

### How It Works

1. Installation: The miniaturized tuning machine is designed to be mounted inside a subsurface pocket in the head, tail, or body. When installed it is virtually completely hidden from view inside the head, tail, or body of the instrument. The strings enter the surface of the instrument and connect directly to the tuning machine as shown in the several drawings. Musical instruments can be designed specifically to use the present invention, which enables an entire new category of smaller, lighter and more portable musical instruments, with significantly lower environmental and energy footprint.
2. Tuning Process: Musicians adjust the tensioning screw, which provides precise control over string tension, ensuring accurate tuning. The string tensioning screw is accessed from the end of the head or tail, enabling tuning without any protruding elements. The tensioning screw has a fine pitch, which enables fine adjustments to achieve precise pitch control. This feature is particularly useful for adjusting to exact pitch requirements.
3. Durability and Maintenance: The design ensures long-lasting performance. Periodic cleaning and lubrication of the micro-adjustment screw will enhance the long-term performance and wear of the components. The design is superior to other tuning machines when protected inside a pocket withing the musical instrument, which protects the tuning machine from the environment, including contaminants. The present tuning machine is hidden in the instrument and generally covered, which enhances the performance and results in less required maintenance.

This present universal miniaturized tuning machine not only solves the common issues associated with traditional tuners, such as weight, bulkiness, and accidental detuning, but also offers a cost-effective solution without compromising quality. Musicians benefit from lighter, more portable instruments that are easier to handle and less prone to damage during travel, making this invention ideal for use in a variety of settings, from rehearsals to performances, adventurous and business travel, and beyond. Major benefits include a significantly reduced environmental and energy footprint for not just the tuning machine, but also for the musical instrument that is designed to maximize the benefits of the invention.

The preferred embodiment of the present invention provides a universal and versatile tuning machine that can be used in any type of instrument with any number of strings, or string gages. The primary application is intended for use in instruments that are designed to use the tuning machine. One particularly valuable embodiment is an instrument where a pocket is created for subsurface mounting of the tuning machine, which enables the tuning machine to be general invisible to the user. This enables all of the benefits described in this disclosure with the addition of a sleek and stylish musical instrument as shown in several drawings. The functions, claims and relevance of the present invention to the current state-of-the-art will be defined in greater detail in the following detailed description of the preferred embodiment in conjunction with the provided drawings.

### BRIEF DESCRIPTION OF THE SEVERAL VIEWS OF THE DRAWINGS

FIG. 1 is a top perspective view of the preferred embodiment of the present invention, showing specifically a three-string configuration, including a Base Part, Tensioning Screw, Carriages, and a separate Tuning Key, prior to installation into a musical instrument.

FIG. 2 is a top perspective view, with the view being opposite of that shown in FIG. 1, of the preferred embodiment of the present invention, showing specifically a three-string configuration, including a Base Part, Tensioning Screw, and Carriages, without the Tuning Key shown, prior to installation into a musical instrument.

FIG. 3 is a top view of the preferred embodiment of the present invention, showing specifically a three-string configuration, including a Base Part, Tensioning Screw, and Carriages, without the Tuning Key shown, prior to installation into a musical instrument.

FIG. 4 is a side view of the preferred embodiment of the present invention, showing specifically a three-string configuration, including a Base Part, Tensioning Screw, and Carriages, without the Tuning Key shown, having a section view of one of the Carriage parts prior to installation into a musical instrument.

FIG. 5 is a perspective view of the preferred embodiment of the present invention installed into a pocket in the back of the head of a generic musical instrument, showing specifically a three-string configuration, including a Base Part, Tensioning Screw, Carriages, and a separate Tuning Key.

FIG. 6 is a perspective view of the preferred embodiment of the present invention installed into a pocket in the back of the head of a generic musical instrument, with the view showing the front of the instrument head, and showing specifically a three-string configuration, including a Base Part, Tensioning Screw, Carriages, and a separate Tuning Key.

FIG. 7 is a top perspective view of the preferred embodiment of the present invention, showing specifically a three-string configuration, including a Base Part, Tensioning Screw, Carriages, and a separate Tuning Key, prior to installation into a musical instrument, and also showing an alternative embodiment where one Carriage has a distal end that will securely hold the ball end of a musical string as is commonly done in industry.

FIG. 8 is a perspective view of the preferred embodiment of the present invention installed into a pocket in the back of the head of a generic musical instrument, showing specifically a three-string configuration, including a Base Part, Tensioning Screw, Carriages, and a separate Tuning Key, as well as an optional cover over the device to protect the device from contaminants and damage, resulting in a hidden installation.

FIG. 9 is a top perspective view of the preferred embodiment of the present invention, showing specifically a three-string configuration, including a Base Part, Tensioning Screw, Carriages, where the head of the Tensioning Screw is formed in the shape of a Knob, and showing the present invention prior to installation into a musical instrument, also showing an alternative embodiment where one Carriage has a distal end that will securely hold the ball end of a musical string as is commonly done in industry.

FIG. 10 is a perspective view of one embodiment of the present invention illustrated in FIG. 9 where the present invention is installed into a pocket in the back of the head of a generic musical instrument, showing specifically a three-string configuration, including a Base Part, Tensioning Screw, Carriages, where the head of the Tuning Key is formed into the shape of a Knob that extends beyond the outer boundary of the instrument, as well as an optional cover over the device to protect the device from contaminants and damage, resulting in a hidden installation.

### DETAILED DESCRIPTION OF THE INVENTION

The present invention relates to a miniaturized Tuning Machine 2 for stringed instruments comprising several components that work together to provide universal, self-contained, small, light, inexpensive, precise and stable string tension adjustments. Each component is designed to fit seamlessly within the overall structure of the instrument while maintaining a compact and lightweight profile. The versatile nature of the invention provides for new avenues for guitar makers to develop light and portable musical instruments that are highly durable, while maintaining high-performance. The Tuning Machine 2 has a significantly smaller environmental and energy footprint than any other tuning machine available in industry or in the present state-of-the-art. This invention enables an entire category of efficient musical instruments that have a significantly lower environmental and energy footprint than comparable musical instruments.

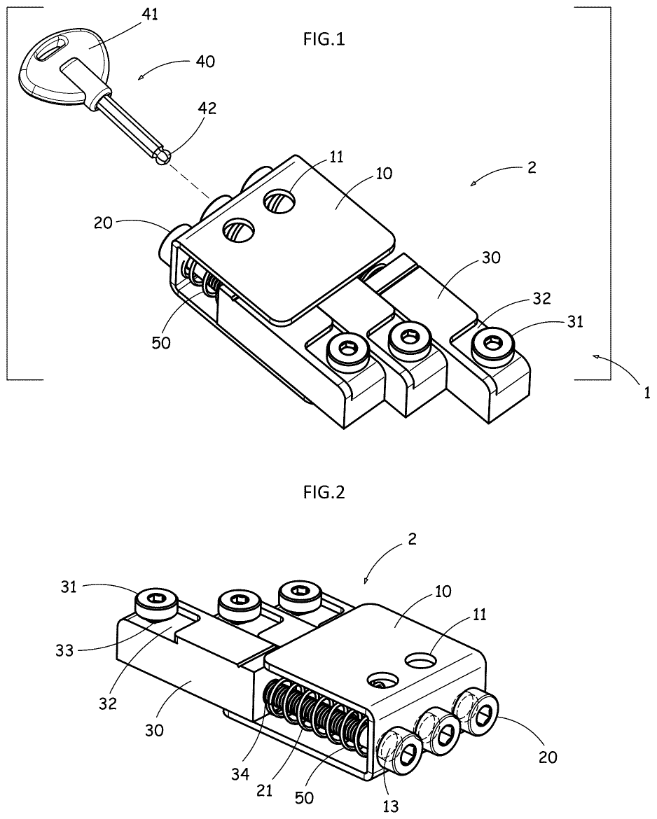

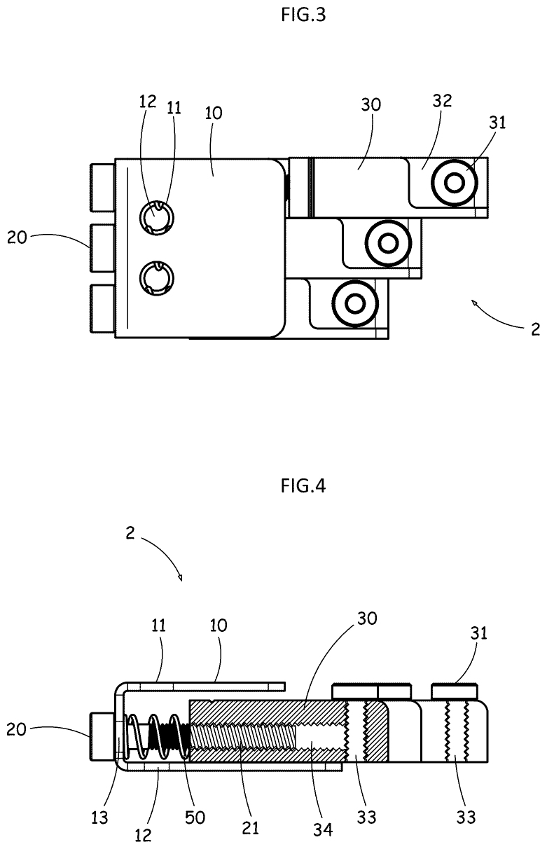

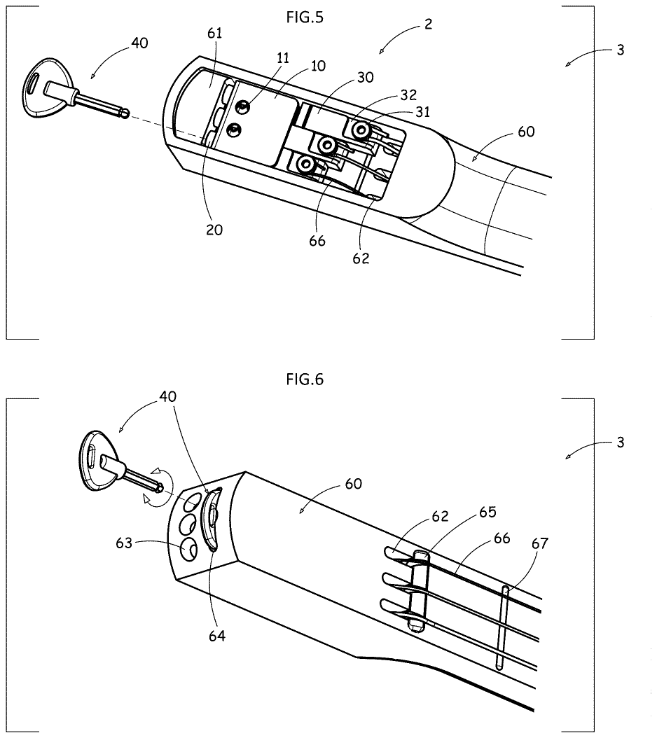

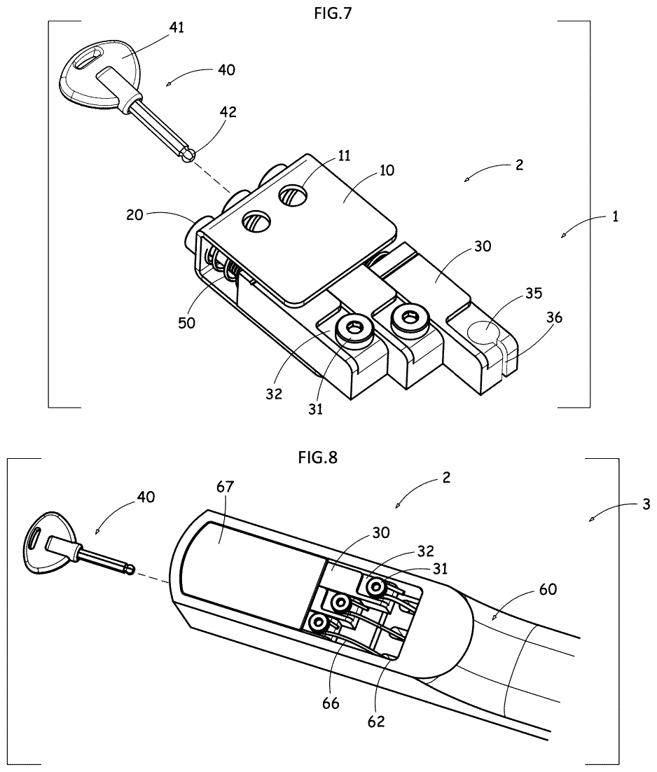

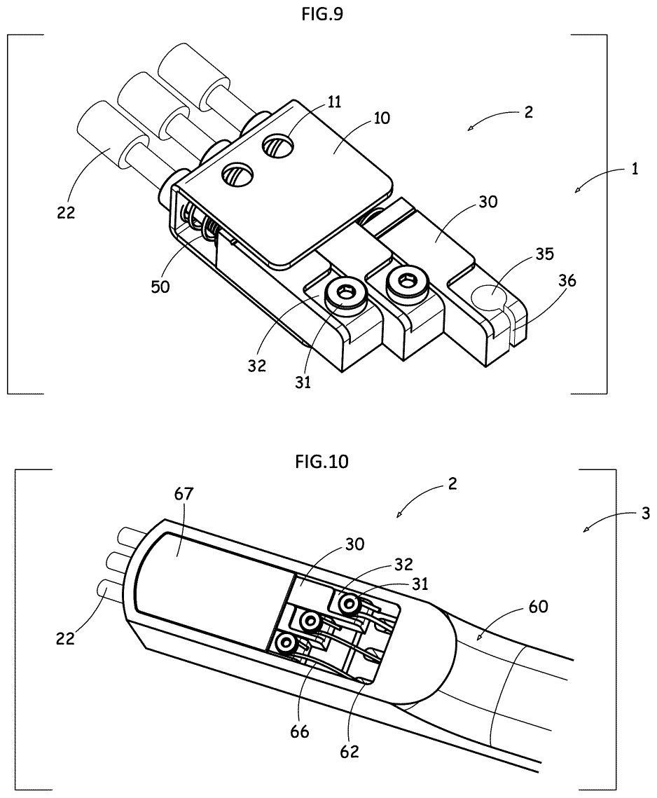

FIG. 1, FIG. 2, FIG. 3 and FIG. 4 provide illustrations of the specific embodiments and elements of the present invention, including context for assembly and use. The embodiments illustrated are configured showing a generic instrument with three strings, but any number of strings can be configured in the device to meet the needs of each instrument. For example, guitars generally have six strings, and banjos can have four strings or five strings, while bass guitars can have any number of much thicker strings. FIG. 5 and FIG. 6 illustrate the embodiments from FIG. 1 through FIG. 4 installed inside of a generic three-stringed musical instrument from a front and rear view. It is noted how the user can use the device. FIG. 7 provides a similar drawing to FIG. 1, but where an alternative embodiment of a secure means of holding the string is in the form of a pocket in the distal end of the Carriage that receives the ball end of a string. Strings are often provided with a ball end to enable secure holding of one end of the string. FIG. 8 illustrates a similar arranged to FIG. 5, with an additional cover piece that both protects the device from becoming contaminated or damaged, while also hiding the device from view to create a sleek and stylish design. FIG. 9 and FIG. 10 provide an illustrations for an alternative embodiment of the Tensioning Screw 20, where the end is formed into the shape of a Tensioning Screw Knob 22 which enables the user to turn the Tensioning Screw 20 with their fingers rather than requiring a separate Tuning Key 40. These figures also illustrate the benefits of the invention to create sleek, stylish, light and portable instruments with all of the benefits described herein.

### Components of the Invention

1. Base Part (10): The Base Part 10 serves as the main structural component of the present invention, housing and supporting the internal parts of the Tuning Machine 2 and providing means for connecting to the Instrument 60. The Base Part 10 is made from high-strength, corrosion-resistant material to ensure longevity and robustness. The Base Part 10 can be shaped so as to protect the device from damage, to enable fastening of the device to the Instrument 66, and can also be shaped to fully house the device in an enclosed form. The embodiments illustrated in the drawings does not limit the shape of the Base Part 10 to meet the needs of the particular Instrument 66.
2. Tensioning Screw (20): The Tensioning Screw 20 passes through a Hole 13 in the Base Part 10 and is then inserted into a threaded Tuning Hole 34 in the proximal end of the Carriage 30. One Tensioning Screw 20 is provided for each String 66 of the musical Instrument 60. The Tensioning Screw 20 has fine pitch along the Tensioning Screw Body 21, which enables ultra-fine adjustment of string tension, providing precise control over the natural vibration pitch of the String 66. The Tensioning Screw 20 is designed to be accessed from the end of the head or tail of the instrument, enabling adjustments without any protruding elements and preventing accidental detuning. The head geometry of the Tensioning Screw 20 may be formed in the integrated shape of a Tensioning Screw Knob 22, as shown in FIG. 9 and FIG. 10, which can allow it to extend beyond the instrument boundaries for the user to easily access the Tensioning Screw 20 with their fingers rather than requiring a separate Tuning Key 40. One embodiment provides for the Tensioning Screw Knob 22 to be formed in a way such that the Tensioning Screw Knob 22 is a separate part that is connected to the end of the Tensioning Screw 20, as is commonly performed in the industry.
3. Carriage (30): The Carriage 30 has a threaded Tuning Hole 34 starting in the proximal end and extending through the center of the Carriage 30, as shown in FIG. 4, where the Tensioning Screw 20 is threaded into, and on the distal end, has means for semi-permanently and securely holding the instrument String 66. One Carriage 30 is provided for each String 66 of the musical Instrument 60. Several embodiments for connection of the String 66 to the distal end of the Carriage 30 are disclosed in this specification. Many commonly used methods for securely holding the String 66 in the state-of-the-art are provided for and discussed in this specification. The preferred embodiment of the Carriage 30 uses a simple Clamping Screw 31 that is inserted into a threaded Clamping Screw Hole 33 in the distal end of the Carriage 30. The String 66 is wrapped around the threaded portion of the Clamping Screw 31 and when said Clamping Screw 31 is fully inserted compresses the String 66 between the underside of the Clamping Screw 31 head and the Compression Surface 32 of the Carriage 30. This method provides a simple and secure method of holding the String 60. Another means of securely holding the end of the String 66 on the distal end of the Carriage 30 is illustrated on FIG. 7, where a cylinder-shaped pocket called a String Ball End Pocket 35 is provided, which enables the user to use a ball end on the String 66 to securely hold the end of the String 66 as is commonly done in the industry. The ball end of the string is placed into the Ball End Pocket 35, and the String 66 passed through a String Slot 36 where it then is terminated at the far end of the Instrument 60. Several other common industry methods for holding the String 66 are provided in this specification.
4. Tensioning Key (40): The Tensioning Key 40 is used to rotate the Tensioning Screw 20 in the threaded Tuning Hole 34 in the proximal end of the Carriage 30, changing the relative distance between the proximal end of the Tensioning Screw 20 head and the Carriage 30, thereby adjusting string tension. The Carriage 30 is restrained from rotating by the string force pulling the Carriage 30 downward where is slides along the bottom of the Base Part 10, or the Instrument 60. The Carriage 30 is further prevented from rotating due to the interactions with the Instrument 60, and/or the adjacent Carriage 40. The Tensioning Key 40 can be integrated into the tuning system or can be separate from the Tuning Machine 2 and the Instrument 60. The preferred embodiment of the Tuning Key 40 is such that it is small and light and can potentially be stored in a Key Pocket 64 in the Instrument 60, as shown in FIG. 5 and FIG. 6. The particular shape of the Tuning Key 40 is not particularly important so long as the Key Body 41 enables the user to apply torsional force to turn the Tensioning Screw 20 and the Key Tool 42 is property formed to securely engage with the end of the Tensioning Screw 20.
5. Optional Compression Spring (50): This optional spring ensures that the Carriage 30 is maintained in the extended position, whether or not there is a String 66 attached. The tuning machine functions effectively even without the spring.
6. Other Components in Use:
   1. Instrument (60): The stringed instrument itself, such as a guitar, violin, ukulele, banjo, mandolin, or bass guitar. The present invention is compatible with any type of instrument, especially with those design to use the invention.
   2. Instrument String (66): The musical string that is securely held by the Carriage 30 and tensioned by the Tuning Machine 2. The type of string is specific to the type of instrument or the preference of the musician. Many variations of Strings 66 are available, including those with ball ends, which is common in the industry.
   3. Instrument Fret (67): The instrument fret is noted here as most stringed musical instrument have frets to change the relative string length during playing and therefore the string pitch.

The Tuning Machine 2 is assembled by passing the Tensioning Screw 20 through a Hole 13 in the Base Part 10, where the bottom side of the screw head cannot pass through the Hole 13, so bears against the Base Part 10. The Carriage 30 is brought into proximity of the threaded end of the Tensioning Screw 20 and is screwed into the threaded Tuning Hole 34 of the Carriage 30. As the Tensioning Screw 20 is turned the distance between the head of the Tensioning Screw 20 and the proximal end of the Carriage 30 is reduced. This results in tensioning of the String 66 once attached to the distal end of the Carriage 30. If the Optional Compression Screw 50 is desired, it is assembled along the length of the Tensioning Screw 30 just prior to attaching to the proximal end of the Carriage 30. The Optional Compression Spring 50 is not needed for device primary function, but when used it ensures the Carriage 30 is always presented in the extended position while outside of the Instrument 60.

### Installation

1. Subsurface Installation: The preferred embodiment of the Tuning Machine 2 is installed in a Subsurface Pocket 61 of the Instrument 60, completely hidden from normal view. The Tuning Machine 2 is secured inside the Instrument 60 using any common fastening method, such as screws, as discussed herein. The instrument designer may choose to install a Cover 67 as shown in FIG. 8, over the Tuning Machine 2, which can protect the Tuning Machine 2 from contaminants and damage, while also creating a sleek and stylish instrument appearance.
2. Stringing the Instrument: The Strings 66 are installed onto the Instrument 60 in the preferred embodiment by passing the strings through the String Slots 62, where they are connected to the distal end of the Carriage 30 which has several potential means for securing the String 66. The path of the String 66 on the specific Instrument 60 is the option of the designer of the Instrument 60, or the preference of the musician. The connection of the String 66 to the Carriage 30 can be accomplished in several ways as disclosed herein and as shown in the Drawings. The preferred embodiment enables the Strings 66 to enter the Instrument 60 surface and connect directly to the Carriage 30 of the Tuning Machine 2, maintaining a sleek and streamlined appearance.

### Operation

1. Tuning Process: Changing the tension of the String 66 is accomplished by the musician by using rotating the Tensioning Screw, which is different for varying embodiments. One embodiment is to use a tool such as the Tuning Key 40. In the preferred embodiment where the Tuning Machine 2 is installed inside a pocket in the Instrument 60, the user passes the end of the Tuning Key 40 through a Tuning Key Hole 63 in the Instrument 60 until it engages with the head of the Tensioning Screw 20. The Tensioning Screw 20 and Tensioning Key 40 provide the ability of the musician to precisely control the tension and pitch of the String 66 with minimal effort. In another embodiment, the head of the Tensioning Screw 20 further comprises an integrated, or separate knob shape, which allows the user to turn the Tensioning Screw 20 using their fingers rather than a tool as shown in FIG. 9 and FIG. 10.
2. Preventing Accidental Detuning: The hidden placement of the Tuning Machine 2 and Tensioning Screw 20 ensures that they cannot be accidentally bumped, preventing unintentional detuning. This design feature enhances the reliability and stability of the instrument during performances.
3. Storage of the Tuning Key: The Tuning Key 40, in the preferred embodiment, being separate from the main Tuning Machine 2, can be stored separately or can be stored in a Key Pocket 64 on the Instrument. The Tuning Key 40 is temporarily and securely held in place through several potential methods, including friction, or a magnetic clasp.

### Durability and Maintenance

1. Durable Construction: The tuning machine's components are made from high-strength, corrosion-resistant materials, ensuring long-lasting performance even under rigorous use.
2. Minimal Maintenance: The design requires minimal maintenance, with periodic cleaning and lubrication of the tensioning screw to maintain smooth operation and longevity. The device can also be covered to improve resistance to contamination.
3. Environmental Resilience: The tuning machine is designed to maintain consistent performance despite changes in temperature, humidity, and other environmental factors.

### Common Methods for Connecting Components to Stringed Instruments

Stringed instruments often require various methods to connect and secure components. Guitars have many components fastened to them including mechanical and electrical hardware, including tuning machines. Common techniques include:
1. Screws: Utilized for attaching parts such as tuning pegs, bridges, and pickups. Screws offer strong, removable connections that ensure components remain securely affixed.
2. Pins: These are used for fitting parts like tailpieces and fingerboards. Pins provide precise alignment and secure fittings but are generally not meant for frequent removal.
3. Bolts and Nuts: Commonly used in electric guitars for affixing necks to the body. This method allows for strong and adjustable connections.
4. Glue: Traditional luthiers often use hide glue or modern synthetic adhesives to bond parts permanently, such as the neck to the body or the top plate to the sides.
5. Clamps: Temporary clamps are used during the construction or repair processes to hold parts together while gluing.

### Industry Practices for Housing Components Inside Stringed Instruments

Housing components within stringed instruments must be done in ways that maintain the instrument's structural integrity and sound quality. Common practices include:
1. Subsurface Pockets: Components such as preamps or internal microphones are housed in pockets carved or routed into the instrument's body, usually hidden from view.
2. Bracing and Support: Instruments like guitars and violins have internal bracing to support the components housed within, ensuring they don't compromise the instrument's resonance.
3. Enclosures: Electrical components in electric guitars are often housed in shielded enclosures to prevent electromagnetic interference while maintaining a clean internal layout.
4. Compartmentalization: Separate compartments can be created within the body for specific components, ensuring they are securely held without affecting other parts.

### Methods for Securing Strings in Stringed Instruments

Securing musical instrument strings is crucial for stable tuning and playability. Many methods for securing strings are disclosed here to reserve other methods of connection to the Carriage that are available in the current state-of-the-art. Current methods include:
1. Bridge Pins: Used primarily in acoustic guitars, bridge pins anchor the strings into the bridge, creating a secure hold.
2. Ball-End Locks: Strings with ball ends are secured into bridge slots, common in electric and bass guitars.
3. Tie Blocks: Classical guitars use tie blocks where strings are looped and tied to secure them to the bridge.
4. Locking Tuners: These are tuning machines with built-in mechanisms that clamp the string, preventing slippage.
5. Friction Pegs: Found in instruments like violins, friction pegs use frictional force to hold strings in place within the pegbox.

### Claimed Alternatives in This Tuning Machine for Securely Holding Strings

The miniaturized tuning machine for stringed instruments includes various alternatives to securely hold the end of the Strings 66 in the distal end of the Carriage 30, beyond the mentioned Camping Screw 31:
1. Clamp Mechanism: A small clamp that firmly grips the string end, adjustable for tightness.
2. Locking Pin: A pin that passes through the string's loop, locking it securely in place.
3. Ball-End Lock: A slot within the carriage where the ball-end of the string is seated and locked.
4. Set Screw: A set screw presses the string against a flat surface or within a groove.
5. Self-Locking Mechanism: Angled grooves in the carriage hold the string end securely with counter-tension.
6. Spring-Loaded Clamp: A spring-loaded clamp maintains consistent pressure to hold the string.
7. Tuning Peg Grip: A wrap-around grip, similar to traditional tuning pegs, wraps and secures the string, adding friction for stability.
8. Hook and Slot: A hook on the carriage holds the looped string end in a specially designed slot.
9. Dual-Plate Clamp: Two plates sandwich the string end, tightened by screws to hold the string securely in place.

### Example Usage

1. Example 1: The miniaturized tuning machine installed on a guitar headstock. Its compact and hidden design fits neatly within the headstock, providing precise tuning without adding significant weight or bulk.
2. Example 2: The tuning machine used on a violin. The smaller size and light weight of the tuning machine do not affect the instrument's balance, making it easier for the musician to handle and play.
3. Example 3: A custom-built ukulele with miniaturized tuning machine. The sleek, streamlined design of the instrument is enhanced by the compact tuners, providing both aesthetic appeal and functional reliability.
4. Example 4: Installation of the tuning machine in a banjo. The compact nature of the tuning machine allows for a discrete installation, maintaining the instrument's traditional appearance while offering modern tuning precision.
5. Example 5: Use of the tuning machine in a bass guitar. The tuning machine supports multiple heavy gauge strings, providing stable and precise tuning for the instrument.

What is claimed is:

1) A miniaturized universal tuning machine for precise and stable tensioning of musical instrument strings, comprising:
a) A base part as a structural framework for said tuning machine, comprising the main body of said base part, having screw holes and features for supporting elements of said tuning machine, and means for connecting said tuning machine to said musical instrument;
b) A tensioning screw with a head, a threaded body, and a tip;
c) wherein said tensioning screws are supported on the underside of said screw head by passing through said screw holes in said base part;
d) wherein said screw holes are sized to allow said tensioning screw tip and tensioning screw body to pass through said screw hole, but not to allow said tensioning screw head to pass through said screw hole;
e) wherein said tensioning screw body is passed through said screw hole in said base part until the underside of said tensioning screw head bears on said base part near said screw hole;
f) A carriage with two ends, wherein the first end comprises a threaded hole to accommodate said threaded body of said tensioning screw, and the second end comprising means for securely holding said musical instrument string;
g) wherein said threaded body of said tensioning screw is inserted into said threaded hole on first end of said carriage;
h) wherein said tensioning screw is rotated to change the relative distance between bottom of said tensioning screw head and said carriage to apply varying tension force to said musical instrument string;
i) wherein said tuning machine is installed inside of a pocket in said musical instrument, which allows for said tuning machine to be hidden inside said musical instrument and protected from contaminants, and the physical environment.

2) The miniaturized tuning machine of claim 1, wherein said head of said tensioning screw is formed into the geometry of a knob that extends through outer boundary of said musical instrument allowing the user to adjust said tensioning screw with their fingers rather than a separate tool.

3) The miniaturized tuning machine of claim 2, wherein said head of said tensioning screw formed into the shape of knob is a separate part that is connected to said tensioning screw as is commonly done in industry.

4) The miniaturized tuning machine of claim 1, further comprising a separate tensioning key; wherein said tensioning key has a body end and a tool end, wherein the user temporarily mates said tool end of said tensioning key to said head of said tensioning screw, then applies torque to said body of said tensioning key thereby turning said tensioning screw.

5) The miniaturized tuning machine and tensioning key of claim 4, wherein said tensioning key is stored on, or inside of a matching feature of said musical instrument.

6) The miniaturized tuning machine of claim 1, further comprising an optional compression spring loosely installed over said body of said tensioning screw between the end of the base part and the proximal end of the carriage, which ensures said tensioning screw head remains in contact with said base part at all times.

7) The miniaturized tuning machine of claim 1, wherein the means of securing said instrument string comprises a threaded hole in second end of said carriage which accommodates a string locking screw, and when said locking screw is fully inserted compresses said string between the underside of said locking screw head and the surface of said carriage.

8) The miniaturized tuning machine of claim 1, wherein the means of securing the instrument string is a locking pin that passes through the string's loop and locks it in place.

9) The miniaturized tuning machine of claim 1, wherein the means of securing the instrument string is a ball-end pocket that seats the ball-end of the string within the distal end of the carriage.

10) A miniaturized universal tuning machine for precise and stable tensioning of musical instrument strings, comprising:
a) A base part as a structural framework for said tuning machine, comprising the main body of said base part, having screw holes and features for supporting elements of said tuning machine, and means for connecting said tuning machine to said musical instrument;
b) A tensioning screw with a head, a threaded body, and a tip;
c) wherein said tensioning screws are supported on the underside of said head by passing through said screw holes in said base part;
d) wherein said screw holes are sized to allow said tensioning screw tip and tensioning screw body to pass through said screw hole, but not to allow said tensioning screw head to pass through said screw hole;
e) wherein said tensioning screw body is passed through said screw hole in said base part until the underside of said tensioning screw head bears on said base part near said screw hole;
f) A carriage with two ends, wherein the first end comprises a threaded hole to accommodate said threaded body of said tensioning screw, and the second end comprising means for securely holding said musical instrument string;
g) wherein said threaded body of said tensioning screw is inserted into said threaded hole on first end of said carriage;
h) wherein said tensioning screw is rotated to change the relative distance between bottom of said tensioning screw head and said carriage to apply varying tension force to said instrument string.

11) The miniaturized tuning machine of claim 10, wherein said tuning machine is installed inside of a pocket in said musical instrument, which allows for said tuning machine to be hidden inside said musical instrument and protected from contaminants and the physical environment.

12) The miniaturized tuning machine of claim 10, wherein said head of said tensioning screw is formed into the geometry of a knob that extends through outer boundary of said musical instrument allowing the user to adjust said tensioning screw with their fingers rather than a separate tool.

13) The miniaturized tuning machine of claim 12, wherein said head of said tensioning screw formed into the shape of knob is a separate part that is connected to said tensioning screw as is commonly done in industry.

14) The miniaturized tuning machine of claim 10, further comprising a separate tensioning key; wherein said tensioning key has a body end and a tool end, wherein the user temporarily mates said tool end of said tensioning key to said head of said tensioning screw, then applies torque to said body end of said tensioning key thereby turning said tensioning screw.

15) The miniaturized tuning machine and tensioning key of claim 14, wherein said tensioning key is stored on, or inside of a matching feature of said musical instrument.

16) The miniaturized tuning machine of claim 10, further comprising an optional compression spring loosely installed over said body of said tensioning screw between the end of the base part and the proximal end of the carriage, which ensures said tensioning screw head remains in contact with said base part at all times.

17) The miniaturized tuning machine of claim 10, wherein the means of securing said instrument string comprises a threaded hole in second end of said carriage which accommodates a string locking screw, and when said locking screw is fully inserted compresses said string between the underside of said locking screw head and the surface of said carriage.

18) The miniaturized tuning machine of claim 10, wherein the means of securing the instrument string is a locking pin that passes through the string's loop and locks it in place.

19) The miniaturized tuning machine of claim 10, wherein the means of securing the instrument string is a ball-end pocket that seats the ball-end of the string within the distal end of the carriage.
